(19) United States
(12) Patent Application Publication
(10) Pub. No.: US 2024/0039629 A1
(43) Pub. Date: Feb. 1, 2024

(54) LEARNING APPARATUS, OPTICAL SIGNAL STATE ESTIMATION APPARATUS, AND LEARNING METHOD

(71) Applicant: NEC Corporation, Tokyo (JP)

(72) Inventors: Jun Kodama, Tokyo (JP); Yoshiaki Sakae, Tokyo (JP); Yuji Kobayashi, Tokyo (JP); Etsuko Ichihara, Tokyo (JP); Jun Nishioka, Tokyo (JP); Hiroki Tagato, Tokyo (JP); Takashi Konashi, Tokyo (JP)

(73) Assignee: NEC Corporation, Tokyo (JP)

(21) Appl. No.: 18/225,934

(22) Filed: Jul. 25, 2023

(30) Foreign Application Priority Data
Jul. 29, 2022 (JP) 2022-122110

(51) Int. Cl. H04B 10/079; G06N 20/00

(52) U.S. Cl. CPC H04B 10/07953; G06N 20/00

(57) ABSTRACT

A learning model is trained so that a signal state can be estimated with high accuracy even in a case where a constellation on a complex plane is rotated. A learning apparatus (1) includes: an acquisition section (11) that acquires a constellation of a known state optical signal transmitted through optical fiber; a generation section (12) that generates a corrected constellation obtained by rotating the constellation on a complex plane; and a learning section (13) that uses the constellation and the corrected constellation to train a learning model.

This Nonprovisional application claims priority under 35 U.S.C. § 119 on Patent Application No. 2022-122110 filed in Japan on Jul. 29, 2022, the entire contents of which are hereby incorporated by reference.

### TECHNICAL FIELD

The present invention relates to a learning apparatus, an optical signal state estimation apparatus, and a learning method.

### BACKGROUND ART

In recent years, AI-WDM has been actively researched and developed in which a signal state and a fault state are estimated by incorporating a machine learning function in wavelength division multiplexing (WDM), which is an optical signal multiplexing apparatus, and causing the WDM to learn a signal state and parameter information. Examples of a technique related to the above include the following invention disclosed in Patent Literature 1.

Patent Literature 1 discloses that data similar to signal reception data such as constellation data is acquired, feature data is generated, an anormal state of a core is estimated on the basis of the generated feature data, and an estimation result is output.

### CITATION LIST

### Patent Literature

[Patent Literature 1]
Japanese Patent Application Publication Tokukai No. 2019-140666

### SUMMARY OF INVENTION

### Technical Problem

In the process of demodulation (error correction) of an optical signal, the following problem occurs. Specifically, a constellation of a demodulated signal on an IQ plane (complex plane) may be different from a constellation of original data because the constellation of the demodulated signal on the IQ plane is rotated due to a plurality of factors. This makes it impossible to correctly estimate a signal state. Even use of the technique disclosed in Patent Literature 1 is insufficient to solve such a problem.

An example aspect of the present invention has been made in view of the above problems, and an example object thereof is to provide a technique that makes it possible to estimate a signal state with high accuracy even in a case where a constellation on an IQ plane (complex plane) is rotated.

### Solution to Problem

A learning apparatus according to an example aspect of the present invention is a learning apparatus that trains a learning model which estimates a state of an optical signal, the learning apparatus including at least one processor, the at least one processor carrying out: (i) a process for acquiring a constellation of a known state optical signal transmitted through optical fiber; (ii) a process for generating a corrected constellation obtained by rotating the constellation on a complex plane; and (iii) a process for using the constellation and the corrected constellation to train the learning model.

An optical signal state estimation apparatus according to an example aspect of the present invention is an optical signal state estimation apparatus that estimates a state of an optical signal transmitted through optical fiber, the optical signal state estimation apparatus including at least one processor, the at least one processor carrying out: (a) a process for acquiring a constellation of the optical signal; and (b) a process for using a learned model to estimate the state of the optical signal from the acquired constellation, the learned model having been trained with use of a constellation of a known state optical signal and a corrected constellation obtained by rotating the constellation of the known state optical signal on a complex plane.

A learning method according to an example aspect of the present invention is a learning method for training a learning model that estimates a state of an optical signal, the learning method including: acquiring a constellation of a known state optical signal transmitted through optical fiber; generating a corrected constellation obtained by rotating the constellation on a complex plane; and using the constellation and the corrected constellation to train the learning model.

An optical signal state estimation method according to an example aspect of the present invention is an optical signal state estimation method for estimating a state of an optical signal transmitted through optical fiber, the optical signal state estimation method including: acquiring a constellation of the optical signal; and using a learned model to estimate the state of the optical signal from the acquired constellation, the learned model having been trained with use of a constellation of a known state optical signal and a corrected constellation obtained by rotating the constellation of the known state optical signal on a complex plane.

A program according to an example aspect of the present invention is a program for causing a computer to carry out a learning method for training a learning model that estimates a state of an optical signal, the program causing the computer to carry out: (i) a process for acquiring a constellation of a known state optical signal transmitted through optical fiber; (ii) a process for generating a corrected constellation obtained by rotating the constellation on a complex plane; and (iii) a process for using the constellation and the corrected constellation to train the learning model.

### Advantageous Effects of Invention

An example aspect of the present invention makes it possible to estimate a signal state with high accuracy even in a case where a constellation on an IQ plane (complex plane) is rotated.

### BRIEF DESCRIPTION OF DRAWINGS

FIG. 1 is a block diagram illustrating an example configuration of a learning apparatus according to a first example embodiment of the present invention.

FIG. 2 is a flowchart showing a flow of a processing method carried out by the learning apparatus according to the first example embodiment of the present invention.

FIG. 3 is a diagram for describing rotation of a constellation.

FIG. 4 is a block diagram illustrating an example configuration of an optical signal state estimation apparatus according to the first example embodiment of the present invention.

FIG. 5 is a flowchart showing a flow of a processing method carried out by the optical signal state estimation apparatus according to the first example embodiment of the present invention.

FIG. 6 is a block diagram illustrating an example configuration of an optical signal multiplexing apparatus including an optical signal state estimation apparatus according to a second example embodiment of the present invention.

FIG. 7 is a diagram illustrating an example of preprocessing of constellation information.

FIG. 8 is a block diagram illustrating a configuration of a computer functioning as a learning apparatus or an optical signal state estimation apparatus according to each of the example embodiments.

### EXAMPLE EMBODIMENTS

### First Example Embodiment

<Learning Apparatus 1 According to First Example Embodiment>

A first example embodiment of the present invention will be described in detail with reference to the drawings. The present example embodiment is an embodiment serving as a basis for an example embodiment described later. Note that in this overview, reference numerals in the drawings are assigned, for convenience, to respective elements as an example for easier understanding, and are not intended to limit the present invention to aspects illustrated in the drawings. Furthermore, a direction in which connecting lines between blocks in, for example, the drawings to be referred to in the following description extend includes both a single direction and two directions. A unidirectional arrow schematically illustrates a flow of a main signal (data) and is not intended to exclude bidirectionality. Moreover, a point of connection between an input and an output of each of the blocks in the drawings may be configured to be provided with a port or an interface. However, such a configuration is not illustrated.

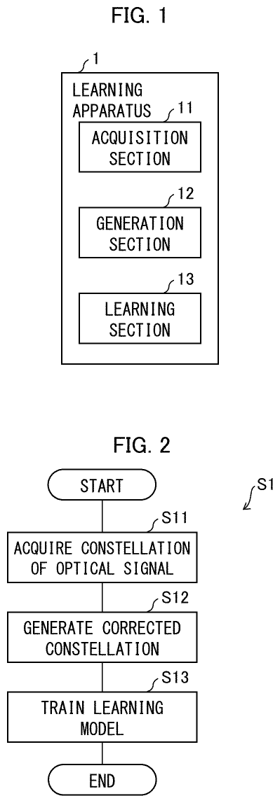

FIG. 1 is a block diagram illustrating an example configuration of a learning apparatus 1 according to the first example embodiment of the present invention. The learning apparatus 1 according to the present example embodiment is a learning apparatus that trains a learning model which estimates a state of an optical signal. The learning apparatus 1 includes an acquisition section 11, a generation section 12, and a learning section 13 as illustrated in FIG. 1.

The acquisition section 11 acquires a constellation of a known state optical signal transmitted through optical fiber. Examples of a known state include signal states such as a noise ratio, crosstalk, and band narrowing. The constellation is a definition of a signal point constellation that indicates a combination of a phase and an amplitude of an in-phase channel (I channel) and a quadrature channel (Q channel) in a digital quadrature modulation method such as QPSK or 16QAM.

In the process of demodulation (error correction) of an optical signal, a constellation of a demodulated signal on an IQ plane (complex plane) may be different from a constellation of original data because the constellation of the demodulated signal on the IQ plane is rotated due to a plurality of factors. Such a phenomenon occurs because constellation data is acquired before demodulation of an optical signal in which a rotation event has occurred. The applicant of the present invention has confirmed that in current AI-WDM, rotation of a constellation on a complex plane occurs in the following four patterns: 0° (no rotation), 90°, 180°, and 270°.

The generation section 12 generates a corrected constellation obtained by rotating the constellation on the complex plane. As described above, rotation of the constellation on the complex plane occurs in the following four patterns: 0°, 90°, 180°, and 270°. Thus, for example, the generation section 12 generates, from the constellation acquired by the acquisition section 11, a first corrected constellation obtained by rotating the constellation by 90 degrees on the complex plane, a second corrected constellation obtained by rotating the constellation by 180 degrees on the complex plane, and a third corrected constellation obtained by rotating the constellation by 270 degrees on the complex plane.

The learning section 13 uses the constellation and the corrected constellation to train the learning model. As described above, the corrected constellation is obtained by rotating the constellation on the complex plane. Thus, by using the corrected constellation together with the constellation to train the learning model, the learning model can be generated so that a signal state can be estimated with high accuracy even in a case where a constellation data rotation event occurs.

The learning section 13 may use, as training data, (i) a set of the constellation and the known state and (ii) a set of the corrected constellation and the known state to train the learning model.

The learning model is, for example, a learning model that has been generated by causing a neural network to carry out deep learning. Note here that examples of the neural network include a convolutional neural network (CNN) and a recurrent neural network (RNN). Note that the learning model is not limited to these configurations and may be exemplified by other machine learning algorithms such as a support vector machine (SVM). Alternatively, the learning model may be a combination of any of these other machine learning algorithms and the neural network. Note that the learning model can also be expressed as an inference model, an estimation model, a discriminative model, or the like.

<Effect of Learning Apparatus 1>

As described above, according to the learning apparatus 1 according to the present example embodiment, the learning section 13 uses the corrected constellation together with the constellation to train the learning model. Thus, the learning model can be generated so that a signal state can be estimated with high accuracy even in a case where a constellation data rotation event occurs.

<Flow of Processing Method Carried Out by Learning Apparatus 1>

The following description will discuss, with reference to FIG. 2, a flow of a processing method carried out by the learning apparatus 1 configured as described above. FIG. 2 is a flowchart showing the flow of the processing method carried out by the learning apparatus 1 according to the first example embodiment of the present invention. As illustrated in FIG. 2, a processing method S1 is a learning method for training a learning model that estimates a state of an optical signal, and the processing method S1 includes steps S11 to S13.

First, the acquisition section 11 acquires a constellation of a known state optical signal transmitted through optical fiber (S11). Examples of a known state include signal states such as a noise ratio, crosstalk, and band narrowing. The constellation is a definition of a signal point constellation that indicates a combination of a phase and an amplitude of an in-phase channel (I channel) and a quadrature channel (Q channel) in a digital quadrature modulation method such as QPSK or 16QAM.

Next, the generation section 12 generates a corrected constellation obtained by rotating the constellation on a complex plane (S12).

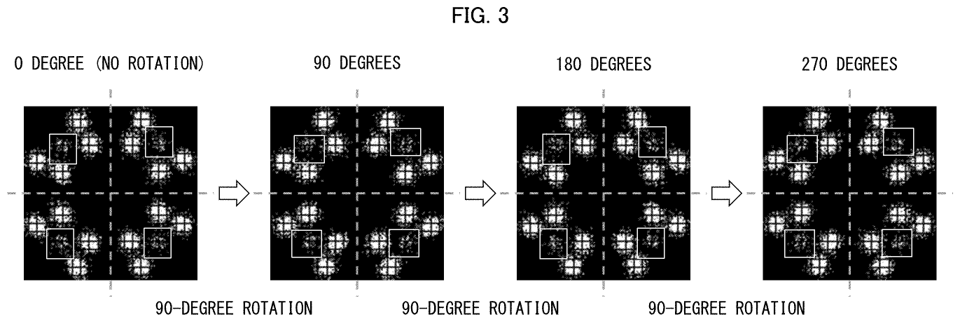

FIG. 3 is a diagram for describing rotation of a constellation. In FIG. 3, a boxed part indicates an auxiliary signal called a pilot signal, which has an influence on the constellation.

The left-end diagram in FIG. 3 illustrates a case where the constellation is rotated by 0° (not rotated) on the complex plane. The second diagram from the left in FIG. 3 illustrates a case where the constellation is rotated by 90° on the complex plane. The third diagram from the left in FIG. 3 illustrates a case where the constellation is rotated by 180° on the complex plane. The right-end diagram in FIG. 3 illustrates a case where the constellation is rotated by 270° on the complex plane.

As illustrated in FIG. 3, the constellation has four rotation patterns, and a signal point to be rotated can be identified. This makes it possible to reproduce a rotation pattern of each constellation by shifting coordinates of a corresponding signal point in a pseudo manner by software processing, and achieve data augmentation.

Finally, the learning section 13 uses the constellation and the corrected constellation to train the learning model (S13). As described above, the corrected constellation is obtained by rotating the constellation on the complex plane. Thus, by using the corrected constellation together with the constellation to train the learning model, the learning model can be generated so that a signal state can be estimated with high accuracy even in a case where a constellation data rotation event occurs.

<Effect of a Processing Method Carried Out by Learning Apparatus 1>

As described above, according to the processing method carried out by the learning apparatus 1 according to the present example embodiment, the learning section 13 uses the corrected constellation together with the constellation to train the learning model. Thus, the learning model can be generated so that a signal state can be estimated with high accuracy even in a case where a constellation data rotation event occurs.

<Optical Signal State Estimation Apparatus 2 According to First Example Embodiment>

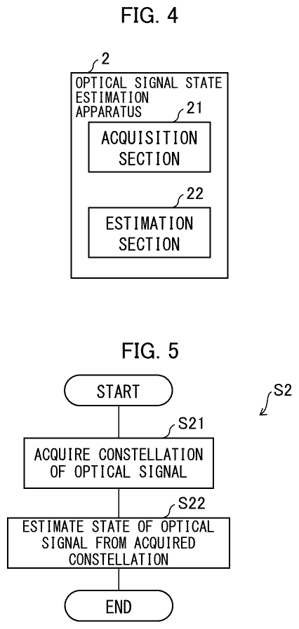

FIG. 4 is a block diagram illustrating an example configuration of an optical signal state estimation apparatus 2 according to the first example embodiment of the present invention. The optical signal state estimation apparatus 2 according to the present example embodiment is an optical signal state estimation apparatus that estimates a state of an optical signal transmitted through optical fiber. The optical signal state estimation apparatus 2 includes an acquisition section 21 and an estimation section 22 as illustrated in FIG. 4.

The acquisition section 21 acquires a constellation of an optical signal. The constellation is a definition of a signal point constellation that indicates a combination of a phase and an amplitude of an in-phase channel (I channel) and a quadrature channel (Q channel) in a digital quadrature modulation method such as QPSK or 16QAM.

The estimation section 22 uses a learned model to estimate the state of the optical signal from the constellation acquired by the acquisition section 21, the learned model having been trained with use of a constellation of a known state optical signal and a corrected constellation obtained by rotating the constellation of the known state optical signal on a complex plane. Examples of a known state include signal states such as a noise ratio, crosstalk, and band narrowing.

Alternatively, the estimation section 22 may use a learned model to estimate the state of the optical signal from the constellation acquired by the acquisition section 21, the learned model having been trained by using, as training data, (i) a set of a constellation of a known state optical signal and a known state, and (ii) a set of a corrected constellation obtained by rotating the constellation of the known state optical signal on a complex plane and the known state.

<Effect of Optical Signal State Estimation Apparatus 2>

As described above, according to the optical signal state estimation apparatus 2 according to the present example embodiment, the estimation section 22 uses the learned model to estimate the state of the optical signal from the constellation acquired by the acquisition section 21, the learned model having been trained with use of the constellation and the corrected constellation. Thus, the estimation section 22 can estimate a signal state with high accuracy even in a case where a constellation data rotation event occurs.

<Flow of Processing Method Carried Out by Optical Signal State Estimation Apparatus 2>

The following description will discuss, with reference to FIG. 5, a flow of a processing method carried out by the optical signal state estimation apparatus 2 configured as described above. FIG. 5 is a flowchart showing the flow of the processing method carried out by the optical signal state estimation apparatus 2 according to the present example embodiment. As illustrated in FIG. 5, a processing method S2 carried out by the optical signal state estimation apparatus 2 is an optical signal state estimation method for estimating a state of an optical signal transmitted through optical fiber, and the processing method S2 includes steps S21 and S22.

First, the acquisition section 21 acquires a constellation of an optical signal (S21). The constellation is a definition of a signal point constellation that indicates a combination of a phase and an amplitude of an in-phase channel (I channel) and a quadrature channel (Q channel) in a digital quadrature modulation method such as QPSK or 16QAM.

Next, the estimation section 22 uses a learned model to estimate the state of the optical signal from the constellation acquired by the acquisition section 21, the learned model having been trained with use of a constellation of a known state optical signal and a corrected constellation obtained by rotating the constellation of the known state optical signal on a complex plane.

<Effect of Optical Signal State Estimation Method>

As described above, according to the optical signal state estimation method according to the present example embodiment, the estimation section 22 uses the learned model to estimate the state of the optical signal from the constellation acquired by the acquisition section 21, the learned model having been trained with use of the constellation and the corrected constellation. Thus, the estimation section 22 can estimate a signal state with high accuracy even in a case where a constellation data rotation event occurs.

### Second Example Embodiment

<Example Configuration of Optical Signal Multiplexing Apparatus 100 According to Second Example Embodiment>

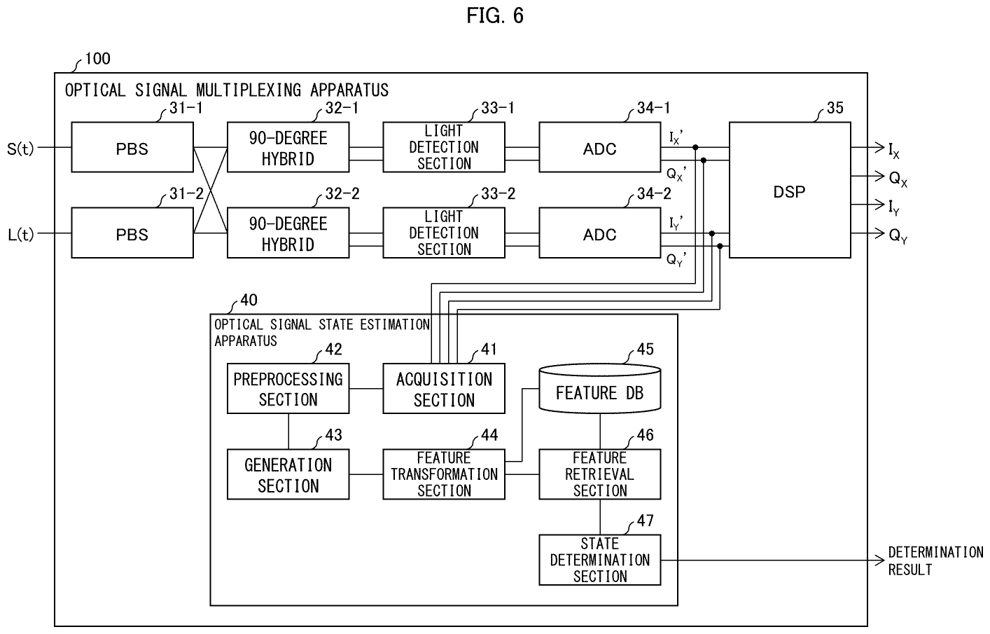

FIG. 6 is a block diagram illustrating an example configuration of an optical signal multiplexing apparatus 100 according to a second example embodiment of the present invention. The optical signal multiplexing apparatus 100 according to the present example embodiment includes polarizing beam splitters (PBSs) 31-1 and 31-2, 90-degree hybrids 32-1 and 32-2, light detection sections 33-1 and 33-2, analog digital converters (ADCs) 34-1 and 34-2, a digital signal processor (DSP) 35, and an optical signal state estimation apparatus 40. FIG. 6 does not illustrate a configuration of an optical signal transmission part of the optical signal multiplexing apparatus 100. Note, however, that the optical signal transmission part can be realized by a common configuration.

The PBS 31-1 carries out polarization separation with respect to an optical signal S (t) input from the communication path, outputs an X-polarized wave to the 90-degree hybrid 32-1, and outputs a Y-polarized wave to the hybrid 32-2. The PBS 31-2 carries out polarization separation with respect to localized light, outputs an X-polarized wave to the 90-degree hybrid 32-1, and outputs a Y-polarized wave to the 90-degree hybrid 32-2.

The 90-degree hybrid 32-1 combines, via two routes that differ in phase by 90 degrees, (i) an X-polarized wave component of the optical signal which is input from the PBS 31-1 and (ii) an X-polarized wave component of the localized light which is input from the PBS 31-2. The 90-degree hybrid 32-1 outputs, to the light detection section 33-1, an in-phase (I-phase) component signal and a quadrature-phase (Q-phase) component signal which have been generated by combining the optical signal and the localized light through the routes that differ in phase by 90 degrees.

The 90-degree hybrid 32-2 combines, via two routes that differ in phase by 90 degrees, (i) a Y-polarized wave component of the optical signal which is input from the PBS 31-1 and (ii) a Y-polarized wave component of the localized light which is input from the PBS 31-2. The 90-degree hybrid 32-2 outputs, to the light detection section 33-2, an I-phase component signal and a Q-phase component signal which have been generated by combining the optical signal and the localized light through the routes that differ in phase by 90 degrees.

Each of the light detection sections 33-1 and 33-2 is made of a photodiode, converts, into an electric signal, an optical signal input thereto, and outputs the electric signal. The light detection section 33-1 converts, into respective electrical signals, (i) an I-phase component optical signal of the X-polarized wave, the I-phase component optical signal being input from the 90-degree hybrid 32-1, and (ii) a Q-phase component optical signal of the X-polarized wave, the Q-phase component optical signal being input from the 90-degree hybrid 32-1, and outputs the electrical signals to the ADC 34-1. The light detection section 33-2 converts, into respective electrical signals, (i) an I-phase component optical signal of the Y-polarized wave, the I-phase component optical signal being input from the 90-degree hybrid 32-2 and (ii) a Q-phase component optical signal of the Y-polarized wave, the Q-phase component optical signal being input from the 90-degree hybrid 32-2, and outputs the electrical signals to the ADC 34-2.

The ADC 34-1 converts, into digital signals, analog signals that are input from the light detection section 33-1, and outputs, to the DSP 35, the digital signals as an I channel Ix′ for the X-polarized wave and a Q channel Qx′ for the X-polarized wave. The ADC 34-2 converts, into digital signals, analog signals that are input from the light detection section 33-2, and outputs, to the DSP 35, the digital signals as an I channel Ty′ for the Y-polarized wave and a Q channel Qy′ for the Y-polarized wave.

The DSP 35 carries out reception processes such as distortion correction, decoding, and error correction with respect to the signals input thereto, demodulates the electric signals that are input from the ADCs 34-1 and 34-2, and outputs the demodulated electric signals as the I channel Ix for the X-polarized wave, the Q channel Qx for the X-polarized wave, the I channel Iy for the Y-polarized wave, the Q channel Qy for the Y-polarized wave.

The optical signal state estimation apparatus 40 includes an acquisition section 41, a preprocessing section 42, a generation section 43, a feature transformation section 44, a feature DB 45, a feature retrieval section 46, and a state determination section 47. The feature transformation section 44, the feature DB 45, the feature retrieval section 46, and the state determination section 47 are configured to achieve an estimation section in the present example embodiment.

The acquisition section 41 acquires a constellation of an optical signal. Specifically, the acquisition section 41 acquires the I channel Ix′ for the X-polarized wave, the Q channel Qx′ for the X-polarized wave, the I channel Ty′ for the Y-polarized wave, and the Q channel Qy′ for the Y-polarized wave. The I channel Ix′ and the Q channel Qx′ are output from the ADC 34-1, and the I channel Ty′ and the Q channel Qy′ are output from the ADC 34-2.

Note that the acquisition section 41 may be configured to acquire the I channel Ix for the X-polarized wave after demodulation, the Q channel Qx for the X-polarized wave after demodulation, the I channel Iy for the Y-polarized wave after demodulation, and the Q channel Qy for the Y-polarized wave after demodulation. The I channel Ix, the Q channel Qx, the I channel Iy, and the Q channel Qy are output from the DSP 35.

The preprocessing section 42 carries out preprocessing with respect to the I channel Ix′ for the X-polarized wave, the Q channel Qx′ for the X-polarized wave, the I channel Ty′ for the Y-polarized wave, and the Q channel Qy′ for the Y-polarized wave, and outputs a processing result to the generation section 43. The I channel Ix′, the Q channel Qx′, the I channel Ty′, and the Q channel Qy′ have been acquired by the acquisition section 41.

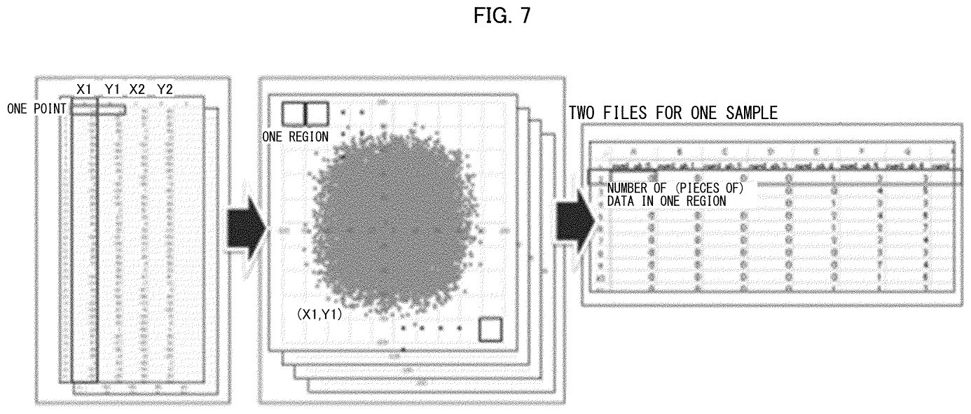

FIG. 7 is a diagram illustrating an example of preprocessing of constellation information. As illustrated at the left end of FIG. 7, the constellation information is acquired as, for example, 8192 pieces or 1108 pieces of two-dimensional coordinate data (one second per sheet).

As illustrated in the center of FIG. 7, after plotting the two-dimensional coordinate data on a complex plane, the preprocessing section 42 divides the complex plane into a plurality of grids of a specific size (e.g., m rows×n columns).

As illustrated at the right end of FIG. 7, the preprocessing section 42 measures the number of signal points included in each of the grids of m rows×n columns, and creates m×n pieces of data. FIG. 7 illustrates a case where the preprocessing section 42 creates two files of the following data: (i) data obtained by preprocessing the constellation information that is output from the ADCs 34-1 and 34-2; and (ii) data obtained by preprocessing the constellation information that is output from the DSP 35.

The generation section 43 generates corrected constellation information obtained by rotating, on the complex plane, the constellation information that has been preprocessed by the preprocessing section 42. Specifically, the generation section 43 generates, as the corrected constellation information, first corrected constellation information obtained by rotating the constellation information by 90 degrees on the complex plane, second corrected constellation information obtained by rotating the constellation information by 180 degrees on the complex plane, and third corrected constellation information obtained by rotating the constellation information by 270 degrees on the complex plane.

The feature transformation section 44 generates a learning model by machine learning with use of (i) the constellation information that has been preprocessed by the preprocessing section 42 and (ii) the corrected constellation information that has been generated by the generation section 43. In this case, the learning model is trained so that features can be extracted from the constellation information and the corrected constellation information. In response to the end of machine learning of the learning model, the feature transformation section 44 uses the learning model generated by machine learning to transform, into a feature, constellation information of a known state optical signal, and accumulates, in the feature DB 45, the feature together with a known state. Note that the known state is, for example, a noise ratio.

The feature DB 45 is constituted by, for example. a nonvolatile memory such as a flash memory, or a hard disk, and sequentially stores and accumulates, in association with each other, (i) the feature obtained by transformation by the feature transformation section 44 and (ii) the known state.

In order to estimate a signal state, by inputting, to a machine-learned learning model, constellation information of an optical signal transmitted through optical fiber, the feature transformation section 44 transforms the constellation information into a feature. The feature retrieval section 46 retrieves the feature stored in the feature DB 45.

In a case where the feature DB 45 stores a feature approximating the feature of the constellation information of the optical signal, the state determination section 47 can determine, for example, a current state of the optical signal by referring to the known state associated with the feature stored in the feature DB 45. The state determination section 47 outputs a determination result to the outside.

<Effect of Optical Signal Multiplexing Apparatus 100>

As described above, according to the optical signal multiplexing apparatus 100 according to the present example embodiment, the generation section 43 generates, as the corrected constellation information, first corrected constellation information obtained by rotating the constellation information by 90 degrees on the complex plane, second corrected constellation information obtained by rotating the constellation information by 180 degrees on the complex plane, and third corrected constellation information obtained by rotating the constellation information by 270 degrees on the complex plane. Thus, the learning model can be generated so that a signal state can be estimated with high accuracy even in a case where a constellation data rotation event occurs.

The optical signal state estimation apparatus 40 uses a learned model to estimate the noise ratio of the optical signal from the constellation acquired by the acquisition section 41, the learned model having been trained with use of a constellation of a known noise ratio optical signal and a corrected constellation obtained by rotating the constellation of the known noise ratio optical signal on the complex plane. Thus, the noise ratio can be estimated with high accuracy even in a case where a constellation data rotation event occurs.

[Software Implementation Example]

Some or all of the functions of each of the learning apparatus 1, the optical signal state estimation apparatus 2 or 40, and the optical signal multiplexing apparatus 100 may be realized by hardware such as an integrated circuit (IC chip) or may be alternatively realized by software.

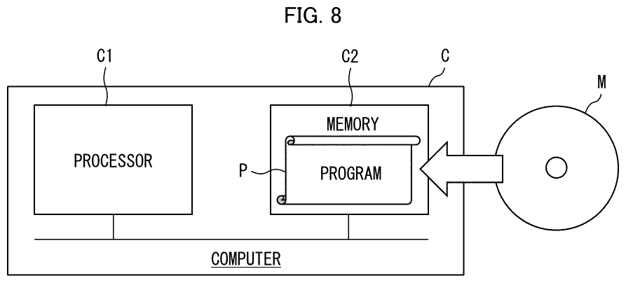

In the latter case, each of the learning apparatus 1, the optical signal state estimation apparatus 2 or 40, and the optical signal multiplexing apparatus 100 is realized by, for example, a computer that executes instructions of a program that is software realizing the functions. FIG. 8 illustrates an example of such a computer (hereinafter referred to as “computer C”). The computer C includes at least one processor C1 and at least one memory C2. The memory C2 stores a program P for causing the computer C to operate as each of the learning apparatus 1, the optical signal state estimation apparatus 2 or 40, and the optical signal multiplexing apparatus 100. In the computer C, the functions of each of the learning apparatus 1, the optical signal state estimation apparatus 2 or 40, and the optical signal multiplexing apparatus 100 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a RAM in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can be transmitted via a transmission medium. The transmission medium may be, for example, a communication network, a broadcast wave, or the like. The computer C can acquire the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can also be described as below. Note, however, that the present invention is not limited to the following example aspects.

(Supplementary Note 1)

A learning apparatus that trains a learning model which estimates a state of an optical signal, the learning apparatus including:
an acquisition section that acquires a constellation of a known state optical signal transmitted through optical fiber;
a generation section that generates a corrected constellation obtained by rotating the constellation on a complex plane; and
a learning section that uses the constellation and the corrected constellation to train the learning model.

(Supplementary Note 2)

The learning apparatus according to Supplementary note 1, wherein the generation section generates, as the corrected constellation, a first corrected constellation obtained by rotating the constellation by 90 degrees on the complex plane, a second corrected constellation obtained by rotating the constellation by 180 degrees on the complex plane, and a third corrected constellation obtained by rotating the constellation by 270 degrees on the complex plane.

(Supplementary Note 3)

The learning apparatus according to Supplementary note 1 or 2, wherein the state is a noise ratio.

(Supplementary Note 4)

An optical signal state estimation apparatus that estimates a state of an optical signal transmitted through optical fiber,
the optical signal state estimation apparatus including:
an acquisition section that acquires a constellation of the optical signal; and
an estimation section that uses a learned model to estimate the state of the optical signal from the constellation acquired by the acquisition section, the learned model having been trained with use of a constellation of a known state optical signal and a corrected constellation obtained by rotating the constellation of the known state optical signal on a complex plane.

(Supplementary Note 5)

The optical signal state estimation apparatus according to Supplementary note 4, wherein the corrected constellation includes a first corrected constellation obtained by rotating the constellation of the known state optical signal by 90 degrees on the complex plane, a second corrected constellation obtained by rotating the constellation of the known state optical signal by 180 degrees on the complex plane, and a third corrected constellation obtained by rotating the constellation of the known state optical signal by 270 degrees on the complex plane.

(Supplementary Note 6)

The optical signal state estimation apparatus according to Supplementary note 4 or 5, wherein the state is a noise ratio.

(Supplementary Note 7)

An optical signal multiplexing apparatus including an optical signal state estimation apparatus according to any one of Supplementary notes 4 to 6.

(Supplementary Note 8)

A learning method for training a learning model that estimates a state of an optical signal,
the learning method including:
acquiring a constellation of a known state optical signal transmitted through optical fiber;
generating a corrected constellation obtained by rotating the constellation on a complex plane; and
using the constellation and the corrected constellation to train the learning model.

(Supplementary Note 9)

An optical signal state estimation method for estimating a state of an optical signal transmitted through optical fiber,
the optical signal state estimation method including:
acquiring a constellation of the optical signal; and
using a learned model to estimate the state of the optical signal from the acquired constellation, the learned model having been trained with use of a constellation of a known state optical signal and a corrected constellation obtained by rotating the constellation of the known state optical signal on a complex plane.

(Supplementary Note 10)

A program for causing a computer to carry out a learning method for training a learning model that estimates a state of an optical signal,
the program causing the computer to carry out:
(i) a process for acquiring a constellation of a known state optical signal transmitted through optical fiber;
(ii) a process for generating a corrected constellation obtained by rotating the constellation on a complex plane; and
(iii) a process for using the constellation and the corrected constellation to train the learning model.

(Supplementary Note 11)

A learning apparatus that trains a learning model which estimates a state of an optical signal,
the learning apparatus including at least one processor, the at least one processor carrying out:
(i) a process for acquiring a constellation of a known state optical signal transmitted through optical fiber;
(ii) a process for generating a corrected constellation obtained by rotating the constellation on a complex plane; and
(iii) a process for using the constellation and the corrected constellation to train the learning model.

Note that the learning apparatus may further include a memory, which may store a program for causing the at least one processor to carry out the process (i), the process (ii), and the process (iii). The program may be stored in a non-transitory tangible computer-readable storage medium.

(Supplementary Note 12)

An optical signal state estimation apparatus that estimates a state of an optical signal transmitted through optical fiber,
the optical signal state estimation apparatus including at least one processor, the at least one processor carrying out:
(a) a process for acquiring a constellation of the optical signal; and
(b) a process for using a learned model to estimate the state of the optical signal from the acquired constellation, the learned model having been trained with use of a constellation of a known state optical signal and a corrected constellation obtained by rotating the constellation of the known state optical signal on a complex plane.

Note that the optical signal state estimation apparatus may further include a memory, which may store a program for causing the at least one processor to carry out the process (a) and the process (b). The program may be stored in a non-transitory tangible computer-readable storage medium.

### REFERENCE SIGNS LIST

1 Learning apparatus
2, 40 Optical signal state estimation apparatus
11, 21, 41 Acquisition section
12, 43 Generation section
13 Learning section
22 Estimation section
31-1, 31-2 PBS
32-1, 32-2 90-degree hybrid
33-1, 33-2 Light detection section
34-1, 34-2 ADC
35 DSP
42 Preprocessing section
44 Feature transformation section
45 Feature DB
46 Feature retrieval section
47 State determination section
100 Optical signal multiplexing apparatus

1. A learning apparatus that trains a learning model which estimates a state of an optical signal,
said learning apparatus comprising at least one processor, the at least one processor carrying out:
(i) a process for acquiring a constellation of a known state optical signal transmitted through optical fiber;
(ii) a process for generating a corrected constellation obtained by rotating the constellation on a complex plane; and
(iii) a process for using the constellation and the corrected constellation to train the learning model.

2. The learning apparatus according to claim 1, wherein in the process (ii), the at least one processor generates, as the corrected constellation, a first corrected constellation obtained by rotating the constellation by 90 degrees on the complex plane, a second corrected constellation obtained by rotating the constellation by 180 degrees on the complex plane, and a third corrected constellation obtained by rotating the constellation by 270 degrees on the complex plane.

3. The learning apparatus according to claim 1, wherein the state is a noise ratio.

4. An optical signal state estimation apparatus that estimates a state of an optical signal transmitted through optical fiber,
said optical signal state estimation apparatus comprising at least one processor, the at least one processor carrying out:
(a) a process for acquiring a constellation of the optical signal; and
(b) a process for using a learned model to estimate the state of the optical signal from the acquired constellation, the learned model having been trained with use of a constellation of a known state optical signal and a corrected constellation obtained by rotating the constellation of the known state optical signal on a complex plane.

5. The optical signal state estimation apparatus according to claim 4, wherein the corrected constellation includes a first corrected constellation obtained by rotating the constellation of the known state optical signal by 90 degrees on the complex plane, a second corrected constellation obtained by rotating the constellation of the known state optical signal by 180 degrees on the complex plane, and a third corrected constellation obtained by rotating the constellation of the known state optical signal by 270 degrees on the complex plane.

6. The optical signal state estimation apparatus according to claim 4, wherein the state is a noise ratio.

7. An optical signal multiplexing apparatus comprising an optical signal state estimation apparatus according to claim 4.

8. A learning method for training a learning model that estimates a state of an optical signal,
said learning method comprising:
acquiring a constellation of a known state optical signal transmitted through optical fiber;
generating a corrected constellation obtained by rotating the constellation on a complex plane; and
using the constellation and the corrected constellation to train the learning model.

9. The learning method according to claim 8, wherein in the generating, a first corrected constellation obtained by rotating the constellation by 90 degrees on the complex plane, a second corrected constellation obtained by rotating the constellation by 180 degrees on the complex plane, and a third corrected constellation obtained by rotating the constellation by 270 degrees on the complex plane are generated as the corrected constellation.

10. The learning method according to claim 8, wherein the state is a noise ratio.
